(19) United States
(12) Patent Application Publication
(10) Pub. No.: US 2026/0001506 A1
(43) Pub. Date: Jan. 1, 2026

(54) AIRBAG CUSHION AND METHOD OF FOLDING AIRBAG CUSHION

(71) Applicant: HYUNDAI MOBIS CO., LTD., Seoul (KR)

(72) Inventor: Sang Won HWANGBO, Yongin-si (KR)

(73) Assignee: HYUNDAI MOBIS CO., LTD., Seoul (KR)

(21) Appl. No.: 19/018,971

(22) Filed: Jan. 13, 2025

(30) Foreign Application Priority Data
Jun. 28, 2024 (KR) 10-2024-0085564

(51) Int. Cl. B60R 21/231; B60R 21/233; B60R 21/2338; B60R 21/237

(52) U.S. Cl. CPC B60R 21/23138; B60R 21/233; B60R 21/2338; B60R 21/237; B60R 2021/23146; B60R 2021/23308; B60R 2021/23386

(57) ABSTRACT

An airbag cushion, a folding method therefor, and an airbag cushion for a vehicle are provided. The airbag cushion includes: a side chamber part combined with a seat part, to be deployed by pressurized gas provided by an inflator, and protect a side of a passenger; a front chamber part connected to the side chamber part, to deploy toward a front of a passenger to protect the passenger; and a shape maintenance part to connect at least one of the side chamber part, the front chamber part, or a combination thereof to the seat part. In response to the side chamber part and the front chamber part being deployed, the shape maintenance part maintains the front chamber part in a bent state with respect to the side chamber part.

### CROSS-REFERENCE TO RELATED APPLICATION

This application claims priority from and the benefit under 35 USC § 119 of Korean Patent Application No. 10-2024-0085564, filed on Jun. 28, 2024, in the Korean Intellectual Property Office, the entire disclosure of which is hereby incorporated by reference for all purposes.

### BACKGROUND

### 1. Field

Exemplary embodiments of the present disclosure relate to an airbag cushion and a folding method of an airbag cushion, and more particularly, to an airbag cushion and a folding method of an airbag cushion, which can protect the omnidirectional direction of a passenger by improving a folding structure of the airbag cushion.

### 2. Description of the Related Art

In general, in the case of an omnidirectional airbag that is deployed in a shape in which the omnidirectional airbag covers both the side and front of a passenger, a front chamber is connected to a side chamber to form an airbag cushion.

The airbag cushion is folded on the left and right sides of a seat back and deployed toward the front of the passenger upon vehicle collision.

In the case of the existing side airbag, an airbag cushion is folded in an inboard folding way to fold the airbag cushion in the direction of a passenger.

The side airbag can be stably deployed although the front end of the airbag cushion interferes with the shoulder of a passenger because the front and rear length (i.e., the front and rear direction of a passenger) of the airbag cushion is relatively short.

However, an omnidirectional airbag cushion has a problem in that a passenger may be damaged because an airbag cushion is deployed between the back of a passenger and a seat or the airbag cushion strongly pushes the shoulder of the passenger forward, if the airbag cushion is folded in an inboard folding way like a side airbag cushion because the front and rear length of the airbag cushion is relatively long. Accordingly, there is a need to improve the problem.

The Background Technology of the present disclosure is disclosed in Korean Patent Application Publication No. 2013-0013975 (Feb. 6, 2013 entitled “Airbag Folding Structure for Vehicle and Method thereof).

### SUMMARY

Various embodiments are directed to providing an airbag cushion and a folding method of an airbag cushion, which can protect the omnidirectional direction of a passenger by improving a folding structure of the airbag cushion.

In a general aspect of the disclosure, an airbag cushion includes: a side chamber part combined with a seat part, and configured to be deployed by pressurized gas provided by an inflator, and protect a side of a passenger; a front chamber part connected to the side chamber part, and configured to deploy toward a front of a passenger to protect the passenger; and a shape maintenance part configured to connect at least one of the side chamber part, the front chamber part, or a combination thereof to the seat part, wherein, in response to the side chamber part and the front chamber part being deployed, the shape maintenance part maintains the front chamber part in a bent state with respect to the side chamber part.

The front chamber part may be folded in a tuck-in way to fold the front chamber part by pushing an end of the front chamber part inward.

The side chamber part may include: a first side part connected to the inflator; a second side part extended from the first side part and configured to protect the side of the passenger; and a third side part extended from the second side part, and configured to: be deployed forward from the second side part; and include a third hole part formed therein.

The first side part may be folded in one or more zigzag patterns to induce lateral deployment with respect to the passenger.

The second side part may be folded in an outboard roll way to fold the second side part in a direction of the passenger so that the second side part is deployed beyond a shoulder portion of the passenger.

The third side part may be folded in an inboard roll way to fold the third side part toward a direction of the passenger.

The airbag cushion may further include one or more tethers configured to limit a deployment thickness, the one or more tethers formed in the second side part.

The front chamber part may be combined with the third side part and deployed toward the front of the passenger by a gas that is discharged through the third hole part.

The shape maintenance part may include: a first upper maintenance part configured to connect an upper part of the side chamber part and an upper part of the seat part; and a second upper maintenance part configured to connect an upper part of the front chamber part and an upper part of the seat part.

The first upper maintenance part and the second upper maintenance part may be overlapped and fixed to the seat part.

The shape maintenance part may further include: a first lower maintenance part configured to connect a lower part of the side chamber part and a lower part of the seat part; and a second lower maintenance part configured to connect a lower part of the front chamber part and a lower part of the seat part.

The first lower maintenance part and the second lower maintenance part may be overlapped and fixed to the seat part.

In another general aspect of the disclosure, a folding method of an airbag cushion, includes: a first folding step of folding a front chamber part configured to protect a passenger by being deployed toward a front of the passenger, the front chamber part connected to a seat part; a second folding step of folding a third side part connected to the front chamber part, the third side part configured to include a third hole part formed therein, and connected to the seat part; a third folding step of folding a second side part connected to the third side part, the second side part configured to protect a side of the passenger; and a fourth folding step of folding a first side part connected to the second side part and an inflator.

The first folding step may include folding the front chamber part in a tuck-in way to fold the front chamber part by pushing an end of the front chamber part inward.

The second folding step may include folding the third side part in an inboard roll way to fold the third side part toward a direction of the passenger.

The third folding step may include folding the second side part in an outboard roll way to fold the second side part in an external direction of the passenger so that the second side part is deployed beyond a shoulder portion of the passenger.

The fourth folding step may include folding the first side part in one or more zigzag patterns so that the first side part is deployed in a lateral direction of the passenger.

In yet another general aspect of the disclosure, an airbag cushion for a vehicle, includes: an airbag inflator; a side chamber part connected to the airbag inflator and configured to be integrated with a seat of the vehicle; a front chamber part connected to the side chamber part and configured to be integrated in the seat of the vehicle; a shape maintenance part configured to attach to the seat and connect at least one of the side chamber part, the front chamber part, or a combination thereof to the seat, wherein, in response to the inflator being deployed, pressurized gas released by the inflator deploys the side chamber part to protect a side of the passenger seated in the seat, the pressurized gas in the side chamber part deploys the front chamber part to protect a front of the passenger seated in the seat, and the shape maintenance part is further configured to maintain the front chamber part as being bent from the side chamber part.

After the side chamber part and the front chamber part are deployed, the shape maintenance part may maintain the side chamber part and the front chamber part as an L-shape when viewed from above, to protect the front and the side of the passenger.

The airbag cushion may further include: another side chamber part connected to the airbag inflator and configured to be integrated with the seat of the vehicle; and another front chamber part connected to the other side chamber part and configured to be integrated in the seat of the vehicle, wherein the shape maintenance part is further configured to connect at least one of the other side chamber part, the other front chamber part, or a combination thereof to the seat, and wherein, in response to the inflator being deployed, pressurized gas released by the inflator deploys the other side chamber part to protect another side of the passenger seated in the seat, the pressurized gas in the other side chamber part deploys the other front chamber part to protect the front of the passenger seated in the seat, and the shape maintenance part is further configured to maintain the other front chamber part as being bent from the other side chamber part.

### BRIEF DESCRIPTION OF THE DRAWINGS

FIG. 1 is a side view schematically illustrating an airbag cushion according to an embodiment of the present disclosure.

FIG. 2 is a cross-sectional view schematically illustrating the state in which the airbag cushion according to an embodiment of the present disclosure has been unfolded before the airbag cushion is folded.

FIG. 3 is a diagram schematically illustrating the state in which the airbag cushion according to an embodiment of the present disclosure is deployed and protects a passenger.

FIG. 4 is a diagram schematically illustrating a seat part according to an embodiment of the present disclosure.

FIG. 5 is a diagram schematically illustrating the folding state of a front chamber part according to an embodiment of the present disclosure.

FIG. 6 is a diagram schematically illustrating the folding state of a third side part according to an embodiment of the present disclosure.

FIG. 7 is a diagram schematically illustrating the folding state of a second side part according to an embodiment of the present disclosure.

FIG. 8 is a diagram schematically illustrating the folding state of a first side part according to an embodiment of the present disclosure.

FIG. 9 is a diagram schematically illustrating the state in which a first upper maintenance part and a second upper maintenance part according to an embodiment of the present disclosure have been connected.

FIG. 10 is a diagram schematically illustrating the state in which a first lower maintenance part and a second lower maintenance part according to an embodiment of the present disclosure have been connected.

FIG. 11 is a flowchart schematically illustrating a folding method of an airbag cushion according to an embodiment of the present disclosure.

FIG. 12 is a plan view schematically illustrating a state before the airbag cushion according to an embodiment of the present disclosure is deployed.

FIG. 13 is a plan view schematically illustrating the state in which the first side part has been deployed in the airbag cushion according to an embodiment of the present disclosure.

FIG. 14 is a plan view schematically illustrating the state in which the second side part has been deployed in the airbag cushion according to an embodiment of the present disclosure.

FIG. 15 is a plan view schematically illustrating the state in which the third side part has been deployed in the airbag cushion according to an embodiment of the present disclosure.

FIG. 16 is a plan view schematically illustrating the state in which the front chamber part has been deployed in the airbag cushion according to an embodiment of the present disclosure.

### DETAILED DESCRIPTION

Hereinafter, an airbag cushion and a folding method of an airbag cushion according to embodiments of the present disclosure are described with reference to the accompanying drawings. In this process, the thicknesses of lines or the sizes of components illustrated in the drawings may have been exaggerated for the clarity of a description and for convenience' sake. Terms to be described below have been defined by taking into consideration their functions in the present disclosure, and may be changed depending on a user or operator's intention or practice. Accordingly, such terms should be defined based on the overall contents of this specification.

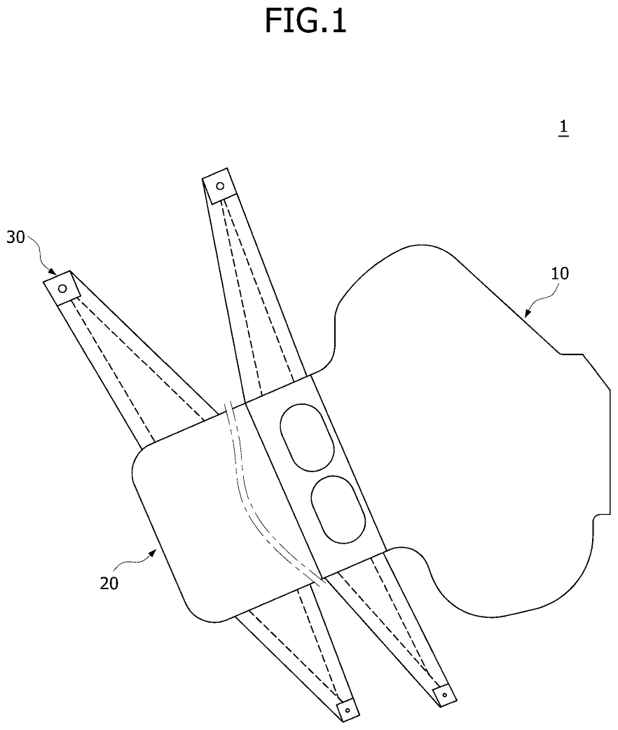

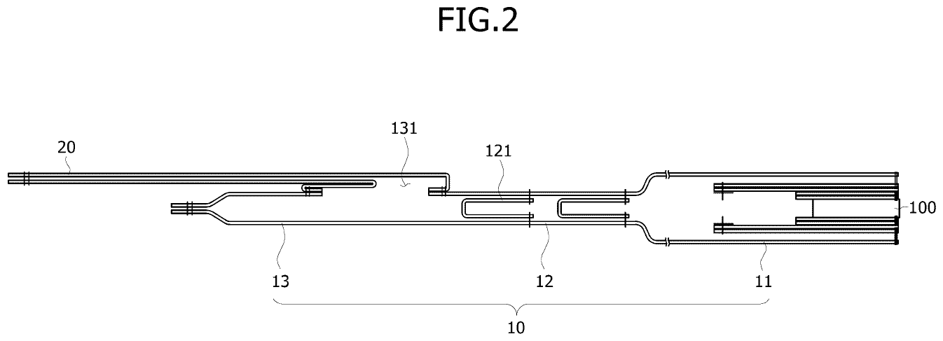

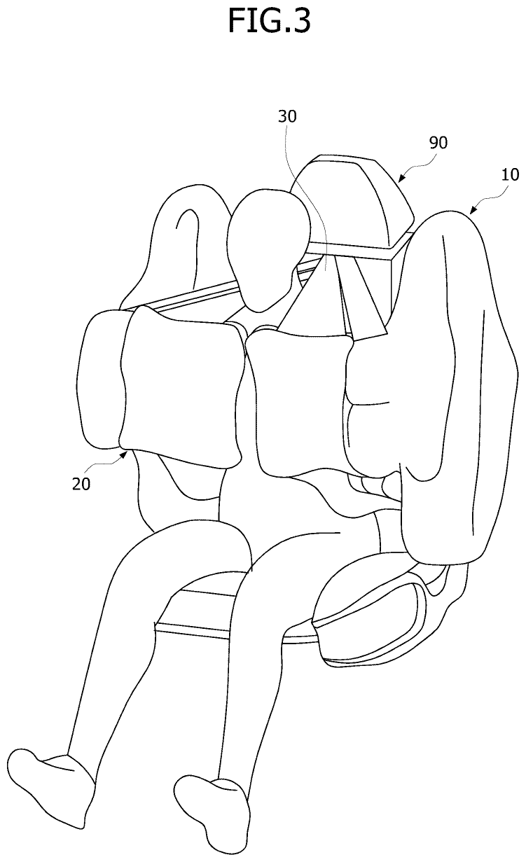

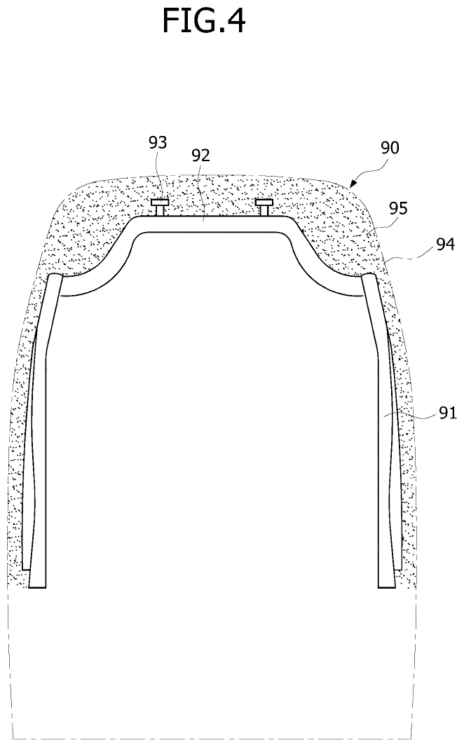

FIG. 1 is a side view schematically illustrating an airbag cushion according to an embodiment of the present disclosure. FIG. 2 is a cross-sectional view schematically illustrating the state in which the airbag cushion according to an embodiment of the present disclosure has been unfolded before the airbag cushion is folded. FIG. 3 is a diagram schematically illustrating the state in which the airbag cushion according to an embodiment of the present disclosure is deployed and protects a passenger. FIG. 4 is a diagram schematically illustrating a seat part according to an embodiment of the present disclosure. Referring to FIGS. 1 to 4, an airbag cushion 1 according to an embodiment of the present disclosure includes a side chamber part 10, a front chamber part 20, and a shape maintenance part 30. The airbag cushion 1 may be disposed on one side or both sides of a seat part 90.

The side chamber part 10 is combined with the seat part 90, and can protect the side of a passenger (occupant) by being deployed by pressure of a gas that is provided by an inflator 100. For example, the side chamber part 10 may be formed by sewing a fabric material. After deployed from the rear of a passenger, the side chamber part 10 can protect the head, shoulder, side chest, and pelvic area of the passenger.

The front chamber part 20 is connected to the side chamber part 10, and can protect a passenger by being deployed toward the front of the passenger. For example, the front chamber part 20 may be formed by sewing a fabric material. The front chamber part 20 is sewed with the side of the side chamber part 10. Some of a gas that is deployed by the side chamber part 10 may deploy the front chamber part 20 through the side chamber part 10. When deployed, the front chamber part 20 can cover the abdomen of a passenger from the bottom of the face.

The shape maintenance part 30 may maintain a shape of the airbag cushion 1 deployed in an approximately L-shape by connecting at least any one of the side chamber part 10 and the front chamber part 20 and the seat part 90.

When the airbag cushion 1 is fully deployed, the shape of the airbag cushion 1 may be approximately L-shaped. As the front chamber part 20 is bent with respect to the side chamber part 10, the airbag cushion 1 may be approximately L-shaped. The approximately L-shaped bending of the front chamber part 20 with respect to the side chamber part 10 may be maintained by the shape maintenance part 30.

For example, the shape maintenance part 30 is fixed and installed at the seat part 90, and may be connected to at least any one of the side chamber part 10 and the front chamber part 20. The shape maintenance part 30 may be fabricated by using a fabric material. The shape maintenance part 30 can maintain the state in which the side chamber part 10 and the front chamber part 20 safely protect a passenger by inducing the side chamber part 10 and the front chamber part 20 that have collided against the passenger to return after being pushed. The shape maintenance part 30 may be formed in the form of a strap or band.

The seat part 90 is mounted on a vehicle body, and may have a shape in which a passenger can be seated. For example, the seat part 90 may include a pair of side frames 91 and an upper frame 92 connected to the pair of side frames 91. The pair of side frames 91 and the upper frame 92 may each be molded by using a metal material. The pair of side frames 91 may be disposed to face each other. The side chamber part 10 and the front chamber part 20 can maintain a folded state in any one of the pair of side frames 91 or the pair of side frames 91. A holder 93 on which a pin for headrest is mounted may be mounted on the upper frame 92. In addition, the seat part 90 may include a covering 94 that covers the pair of side frames 91 and the upper frame 92 and that comes in direct contact with a passenger, and a buffer material 95 that is disposed within the covering 94 and that reduces an impact on a passenger. A breakable cutoff line may be formed in the covering 94 and the buffer material 95. When an airbag operates, the side chamber part 10 and the front chamber part 20 may be deployed to the outside through the cutoff line.

The side chamber part 10 according to an embodiment of the present disclosure may include a first side part 11, a second side part 12, and a third side part 13. The first side part 11, the second side part 12, and the third side part 13 may be integrally formed. In addition, the first side part 11, the second side part 12, and the third side part 13 can maintain the state in which the side chamber part 10 has been sewn and combined with the seat part 90.

The first side part 11 may be connected to the inflator 100. The inflator 100 may be mounted on the side frame 91. One end part of the first side part 11 may be combined to surround the inflator 100. A gas that is discharged by the inflator 100 may be introduced into the first side part 11.

The second side part 12 is extended from the first side part 11 and can protect the side of a passenger. For example, the second side part 12 may have a length in the deployment direction of the second side part from the first side part 11. The second side part 12 may protrude further up and down than the first side part 11. Accordingly, the second side part 12 can protect a passenger from the head to pelvis.

The third side part 13 is extended from the second side part 12 and deployed forward from the second side part 12. A third hole part 131 may be formed in the third side part 13. For example, the third side part 13 may have a length in the deployment direction of the third side part from the second side part 12. The third side part 13 may be deployed to be disposed in the diagonal direction of a passenger.

One or more tethers 121 may be formed in the second side part 12. The tether 121 may be sewn up within the second side part 12 having both ends face each other. The tether 121 may be combined with the second side part 12 in the upper and lower length direction of the second side part 12. One tether 121 may be disposed or a plurality of tethers 121 may be disposed to be spaced apart from each other. When the second side part 12 is expanded, the expansion thickness of the second side part 12 may be limited due to the length of the tether 121. Accordingly, a gas can rapidly pass through the second side part 12 and move to the front chamber part 20.

The front chamber part 20 is combined with the third side part 13, and may be deployed toward the front of a passenger by a gas that is discharged through the third hole part 131. For example, the front chamber part 20 may be sewed to the third side part 13 having an end including the third hole part 131. In addition, a hole corresponding to the third hole part 131 is formed in the front chamber part 20. The state in which the front chamber part 20 and the third side part 13 have been combined can be maintained through the sewing of a part around the hole.

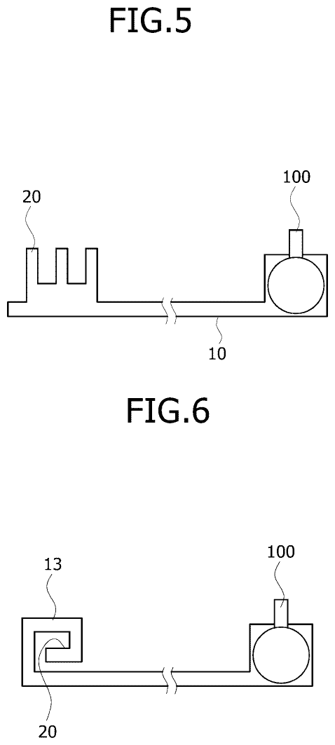

FIG. 5 is a diagram schematically illustrating the folding state of the front chamber part according to an embodiment of the present disclosure. Referring to FIGS. 1 to 5, the front chamber part 20 according to an embodiment of the present disclosure may be folded in a tuck-in way to fold the front chamber part by pushing the end of the front chamber part inward. For example, as the tuck-in way is applied, two concave parts and three protrusion parts may be formed at the end of the front chamber part 20. The tuck-in way can rapidly cover the front of a passenger by increasing the deployment speed of the front chamber part 20 subsequently.

FIG. 6 is a diagram schematically illustrating the folding state of the third side part according to an embodiment of the present disclosure. Referring to FIGS. 1 to 6, the third side part 13 according to an embodiment of the present disclosure may be folded in an inboard roll way to fold the third side part toward the direction of a passenger. For example, the third side part 13 is disposed in the diagonal direction of a passenger in front of the passenger when deployed, and may be folded 180 degrees more than two times in the direction of a passenger. As the third side part 13 is deployed, the third side part 13 may be unfolded in the direction of a passenger, and may induce the front chamber part 20 to be rapidly deployed toward the front of the passenger.

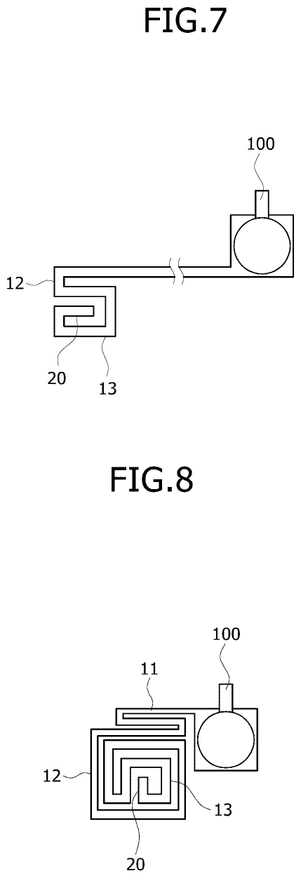

FIG. 7 is a diagram schematically illustrating the folding state of the second side part according to an embodiment of the present disclosure. Referring to FIGS. 1 to 7, the second side part 12 according to an embodiment of the present disclosure may be folded in an outboard roll way to fold the second side part in the direction of a passenger so that the second side part is deployed beyond a shoulder portion of the passenger. For example, when deployed, the second side part 12 may be disposed to cover a passenger from the head to pelvis of the passenger. The second side part 12 may be folded 180 degrees more than three times in a direction opposite to the direction of a passenger. As the second side part 12 is deployed, the second side part 12 may pass by the shoulder of a passenger.

FIG. 8 is a diagram schematically illustrating the folding state of the first side part according to an embodiment of the present disclosure. Referring to FIGS. 1 to 8, the first side part 11 according to an embodiment of the present disclosure may be folded in zigzags in order to induce lateral deployment with respect to a passenger. For example, the first side part 11 may be folded several times in the lateral direction of the seat part 90. In a process of the first side part 11 being deployed, the first side part 11 may be deployed in the diagonal direction behind the passenger's shoulder.

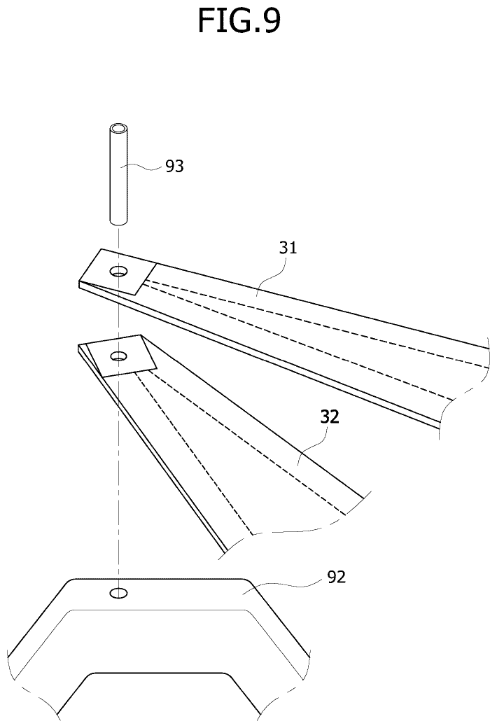

FIG. 9 is a diagram schematically illustrating the state in which a first upper maintenance part and a second upper maintenance part according to an embodiment of the present disclosure have been connected. Referring to FIGS. 3 and 9, the shape maintenance part 30 according to an embodiment of the present disclosure may include a first upper maintenance part 31 and a second upper maintenance part 32.

The first upper maintenance part 31 may connect the upper part of the side chamber part 10 and the upper part of the seat part 90. For example, the first upper maintenance part 31 may be fabricated by using a fabric material. The first upper maintenance part 31 may include a stretchable elastic material. The first upper maintenance part 31 may have a width in which the first upper maintenance part is bonded in the deployment length of the third side part 13, and may have a length in which the location of the third side part 13 is limited. One end part of the first upper maintenance part 31 may be sewn to the upper part of the third side part 13. The other end part of the first upper maintenance part 31 may be combined with the seat part 90. The width of one end part of the first upper maintenance part 31 may be greater than the width of the other end part thereof. The end of the third side part 13 may protrude toward the front of a passenger. The first upper maintenance part 31 may be bonded to the end of the third side part 13. The first upper maintenance part 31 may be formed in the form of a strap or band.

The second upper maintenance part 32 may connect the upper part of the front chamber part 20 and the upper part of the seat part 90. For example, the second upper maintenance part 32 may be fabricated by using a fabric material. The second upper maintenance part 32 may include a stretchable elastic material. The second upper maintenance part 32 may have a width in which the second upper maintenance part is bonded in the deployment length of the front chamber part 20, and may have a length in which the location of the front chamber part 20 is limited. One end part of the second upper maintenance part 32 may be sewn to the upper part of the front chamber part 20. The other end part of the second upper maintenance part 32 may be combined with the seat part 90. The width of one end part of the second upper maintenance part 32 may be greater than the width of the other end part thereof. When deployed, the second upper maintenance part 32 may be disposed to not interfere with the neck of a passenger. The second upper maintenance part 32 may be formed in the form of a strap or band.

The first upper maintenance part 31 and the second upper maintenance part 32 may be overlapped and fixed to the seat part 90. For example, the holder 93 may be mounted on the upper frame 92 by passing through holes that are formed in the other end part of the first upper maintenance part 31 and the other end part of the second upper maintenance part 32. The pin for headrest is mounted within the holder 93. The pin for headrest may be moved up and down, so that the height of the pin can be adjusted.

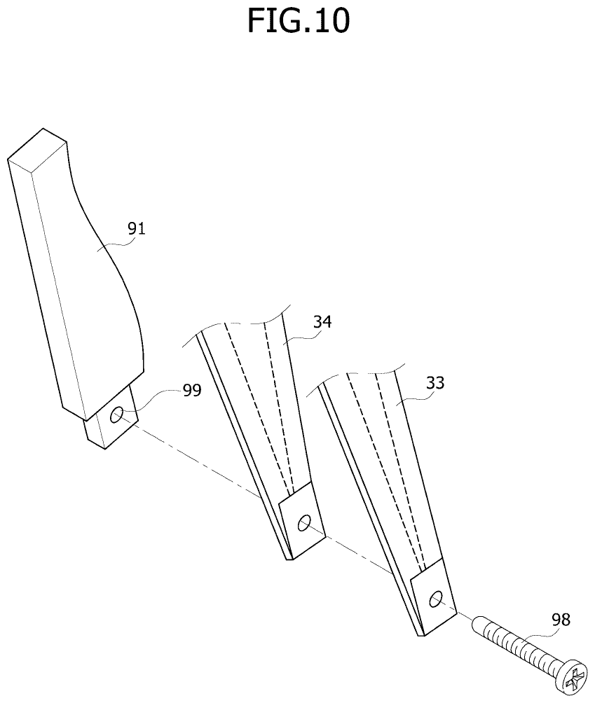

FIG. 10 is a diagram schematically illustrating the state in which a first lower maintenance part and a second lower maintenance part according to an embodiment of the present disclosure have been connected. Referring to FIGS. 3 and 10, the shape maintenance part 30 according to an embodiment of the present disclosure may include a first lower maintenance part 33 and a second lower maintenance part 34.

The first lower maintenance part 33 may connect the lower part of the side chamber part 10 and the lower part of the seat part 90. For example, the first lower maintenance part 33 may be fabricated by using a fabric material. The first lower maintenance part 33 may include a stretchable elastic material. The first lower maintenance part 33 may have a width in which the first lower maintenance part is bonded in the deployment length of the third side part 13, and may have a length in which the location of the third side part 13 is limited. One end part of the first lower maintenance part 33 may be sewn to the lower part of the third side part 13. The other end part of the first lower maintenance part 33 may be combined with the seat part 90. The width of one end part of the first lower maintenance part 33 may be greater than the width of the other end part thereof. The end of the third side part 13 may protrude toward the front of a passenger. The first lower maintenance part 33 may be bonded to the end of the third side part 13. The first lower maintenance part 33 may be formed in the form of a strap or band.

The second lower maintenance part 34 may connect the lower part of the front chamber part 20 and the lower part of the seat part 90. For example, the second lower maintenance part 34 may be fabricated by using a fabric material. The second lower maintenance part 34 may include a stretchable elastic material. The second lower maintenance part 34 may have a width in which the second lower maintenance part is bonded in the deployment length of the front chamber part 20, and may have a length in which the location of the front chamber part 20 is limited. One end part of the second lower maintenance part 34 may be sewn to the lower part of the front chamber part 20. The other end part of the second lower maintenance part 34 may be combined with the seat part 90. The width of one end part of the second lower maintenance part 34 may be greater than the width of the other end part thereof. When deployed, the second lower maintenance part 34 may be disposed to not interfere with the waist of a passenger. The second lower maintenance part 34 may be formed in the form of a strap or band

The first lower maintenance part 33 and the second lower maintenance part 34 may be overlapped and fixed to the seat part 90. For example, a frame hole 99 may be formed in the lower part of the side frames 91. A frame bolt 98 may be mounted on the side frame 91 by passing through holes that are formed in the other end part of the first lower maintenance part 33 and the other end part of the second lower maintenance part 34.

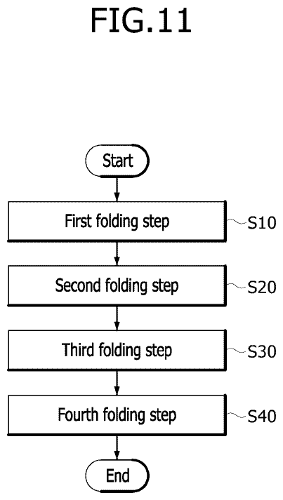

FIG. 11 is a flowchart schematically illustrating a folding method of an airbag cushion according to an embodiment of the present disclosure. A folding process of the airbag cushion is described as follows with reference to FIG. 11.

A first folding step S10 includes folding the front chamber part 20 that protects a passenger by being deployed toward the front of the passenger, that is connected to the side chamber part 10, and that is supported to the seat part 90 by the shape maintenance part 30. The front chamber part 20 may be folded in a tuck-in way to fold the front chamber part by pushing the end of the front chamber part inward. For example, as the tuck-in way is applied, the two concaves and the three protrusions may be formed at the end of the front chamber part 20. The tuck-in way can rapidly cover the front of a passenger by increasing the deployment speed of the front chamber part 20 subsequently (refer to FIGS. 2 and 5). The second upper maintenance part 32 and the second lower maintenance part 34 may be combined with the upper and lower parts of the front chamber part 20. The second upper maintenance part 32 and the second lower maintenance part 34 may be mounted on the seat part 90, and can maintain the location of the front chamber part 20 (refer to FIGS. 3, 9, and 10).

A second folding step S20 includes folding the third side part 13 that is connected to the front chamber part 20, that has the third hole part 131 formed therein, and that is connected to the seat part 90 by the shape maintenance part 30. The third side part 13 may be folded in an inboard roll way to fold the third side part toward the direction of a passenger. For example, the third side part 13 may be disposed in the diagonal direction of a passenger in front of the passenger when deployed, and may be folded 180 degrees more than two times in the direction of a passenger. As the third side part 13 is deployed, the third side part 13 may be unfolded in the direction of a passenger, and may induce the front chamber part 20 to be rapidly deployed toward the front of the passenger (refer to FIGS. 2 and 6). The first upper maintenance part 31 and the first lower maintenance part 33 may be combined with the upper and lower parts of the third side part 13. The first upper maintenance part 31 and the first lower maintenance part 33 may be mounted on the seat part 90, and can maintain the location of the third side part 13 (refer to FIGS. 3, 9, and 10).

A third folding step S30 includes folding the second side part 12 that is connected to the third side part 13 and that protects the side of a passenger. The second side part 12 may be folded in an outboard roll way to fold the second side part in the direction of a passenger so that the second side part is deployed beyond a shoulder portion of the passenger. For example, when deployed, the second side part 12 may be disposed to cover a passenger from the head to pelvis of the passenger. The second side part 12 may be folded 180 degrees more than three times in a direction opposite to the direction of a passenger. As the second side part 12 is deployed, the second side part 12 may pass by the shoulder of a passenger (refer to FIGS. 2 and 7).

A fourth folding step S40 includes folding the first side part 11 that is connected to the second side part 12 and the inflator 100. The first side part 11 may be folded in zigzags in order to induce lateral deployment with respect to a passenger. For example, the first side part 11 may be folded several times in the lateral direction of the seat part 90. In a process of the first side part 11 being deployed, the first side part 11 may be deployed in the diagonal direction of a passenger in the rear of the shoulder of the passenger (refer to FIGS. 2 and 8).

After the front chamber part 20 is sewn to the side chamber part 10, a folding process may be performed. The inflator 100 may be connected to the side chamber part 10 after the folding process, or may be connected to the side chamber part 10 before the folding process. When the folding process is completed, the inflator 100 connected to the side chamber part 10 may be installed in the side frame 91.

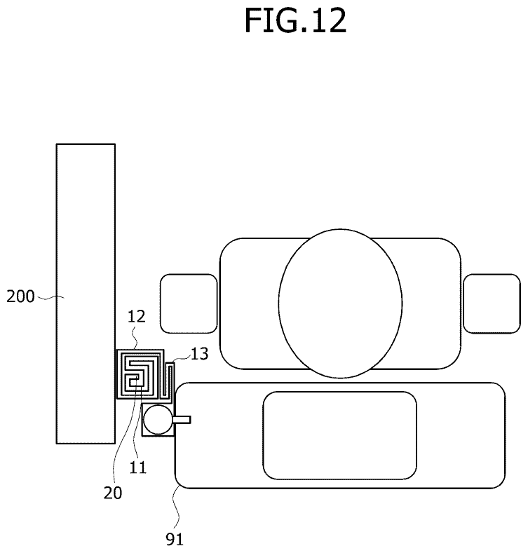

FIG. 12 is a plan view schematically illustrating a state before the airbag cushion according to an embodiment of the present disclosure is deployed. Referring to FIG. 12, the inflator 100 is mounted on the side frame 91 of the seat part 90. The side chamber part 10 connected to the inflator 100 and the front chamber part 20 combined with the side chamber part 10 maintains a folded state. If one airbag cushion 1 is used, the airbag cushion 1 is disposed between the seat part 90 and the vehicle body 200. If two airbag cushions 1 are used, the airbag cushion 1 is mounted on each of the pair of side frames 91.

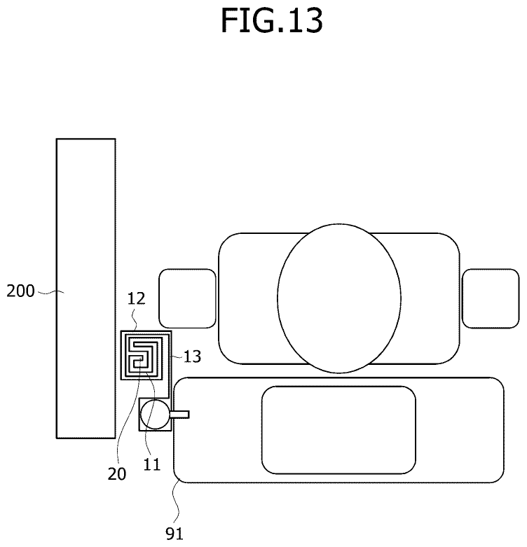

FIG. 13 is a plan view schematically illustrating the state in which the first side part has been deployed in the airbag cushion according to an embodiment of the present disclosure. Referring to FIG. 13, the first side part 11 that has been folded in zigzags is deployed in the diagonal direction behind the passenger's shoulder. When the deployment of the first side part 11 is completed, the second side part 12 is disposed in the diagonal direction behind the passenger's shoulder.

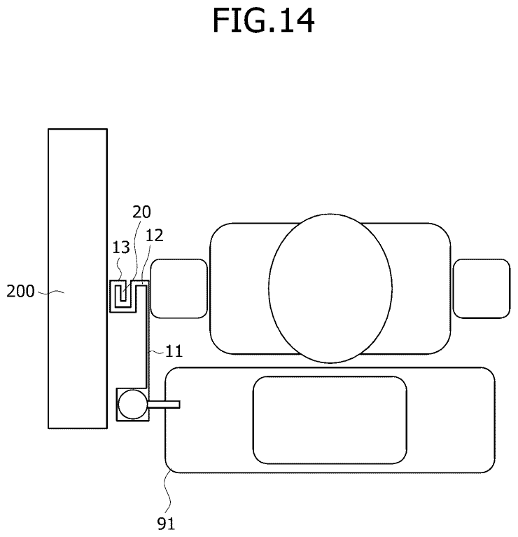

FIG. 14 is a plan view schematically illustrating the state in which the second side part has been deployed in the airbag cushion according to an embodiment of the present disclosure. Referring to FIG. 14, the second side part 12 that is folded in an outboard roll way to fold the second side part in the direction of a passenger so that the second side part is deployed beyond a shoulder portion of the passenger is deployed by bypassing the shoulder of the passenger. When the deployment of the second side part 12 is completed, the second side part 12 protects the side of the passenger by being disposed in the diagonal direction of the passenger in front of the shoulder of the passenger.

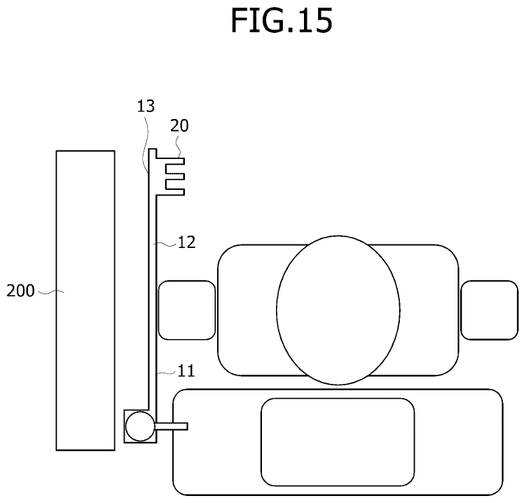

FIG. 15 is a plan view schematically illustrating the state in which the third side part has been deployed in the airbag cushion according to an embodiment of the present disclosure. Referring to FIG. 15, the third side part 13 that is folded in an inboard roll way to fold the third side part toward the direction of a passenger is deployed toward the front of the passenger.

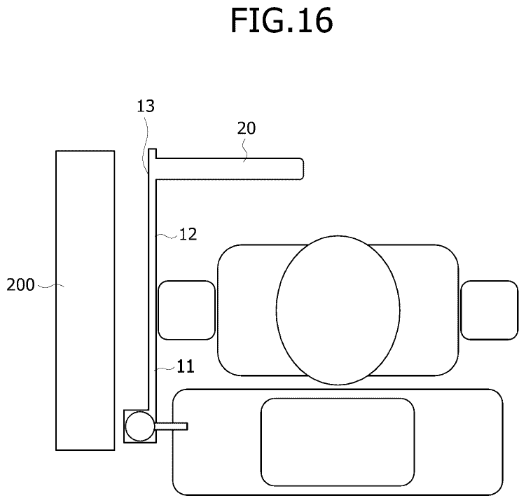

FIG. 16 is a plan view schematically illustrating the state in which the front chamber part has been deployed in the airbag cushion according to an embodiment of the present disclosure. Referring to FIG. 16, the front chamber part 20 that is folded in a tuck-in way to fold the front chamber part by pushing the end of the front chamber part inward is deployed and protects the front of a passenger. If the airbag cushion 1 is disposed only between the vehicle body 200 and the seat part 90 and deployed, the front chamber part 20 may have a deployment length so that the front chamber part can cover the entire front of a passenger. If the airbag cushion 1 is mounted on each of the pair of side frames 91, the front chamber part 20 may have a deployment length so that the front chamber part can cover half of the front of a passenger.

The airbag cushion and the folding method of an airbag cushion according to embodiments of the present disclosure can protect a passenger because the side chamber part 10 is deployed to bypass the shoulder of a passenger without colliding against the shoulder of the passenger and the front chamber part 20 connected to the side chamber part 10 is rapidly deployed toward the front of the passenger.

According to the airbag cushion and the folding method of an airbag cushion according to embodiment of the present disclosure, the side chamber part 10 and the front chamber part 20 can continuously protect a passenger by the shape maintenance part 30 although the passenger protrudes forward and pushes the side chamber part 10 and the front chamber part 20 upon vehicle collision because the shape maintenance part 30 fixes the side chamber part 10 and the front chamber part 20 to the seat part 90. In other words, the front chamber part 20 is maintained in approximately L-shaped bend relative to the side chamber part 10 by the shape maintenance part 30, so that the side chamber part 10 and the front chamber part 20 can continuously protect the passenger.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An airbag cushion comprising:
a side chamber part combined with a seat part, and configured to be deployed by pressurized gas provided by an inflator, and protect a side of a passenger;
a front chamber part connected to the side chamber part, and configured to deploy toward a front of a passenger to protect the passenger; and
a shape maintenance part configured to connect at least one of the side chamber part, the front chamber part, or a combination thereof to the seat part,
wherein, in response to the side chamber part and the front chamber part being deployed, the shape maintenance part maintains the front chamber part in a bent state with respect to the side chamber part.

2. The airbag cushion of claim 1, wherein the front chamber part is folded in a tuck-in way to fold the front chamber part by pushing an end of the front chamber part inward.

3. The airbag cushion of claim 1, wherein the side chamber part comprises:
a first side part connected to the inflator;
a second side part extended from the first side part and configured to protect the side of the passenger; and
a third side part extended from the second side part, and configured to:
be deployed forward from the second side part; and
include a third hole part formed therein.

4. The airbag cushion of claim 3, wherein the first side part is folded in one or more zigzag patterns to induce lateral deployment with respect to the passenger.

5. The airbag cushion of claim 3, wherein the second side part is folded in an outboard roll way to fold the second side part in a direction of the passenger so that the second side part is deployed beyond a shoulder portion of the passenger.

6. The airbag cushion of claim 3, wherein the third side part is folded in an inboard roll way to fold the third side part toward a direction of the passenger.

7. The airbag cushion of claim 3, further comprising:
one or more tethers configured to limit a deployment thickness, the one or more tethers formed in the second side part.

8. The airbag cushion of claim 3, wherein the front chamber part is combined with the third side part and deployed toward the front of the passenger by a gas that is discharged through the third hole part.

9. The airbag cushion of claim 1, wherein the shape maintenance part comprises:
a first upper maintenance part configured to connect an upper part of the side chamber part and an upper part of the seat part; and
a second upper maintenance part configured to connect an upper part of the front chamber part and an upper part of the seat part.

10. The airbag cushion of claim 9, wherein the first upper maintenance part and the second upper maintenance part are overlapped and fixed to the seat part.

11. The airbag cushion of claim 9, wherein the shape maintenance part further comprises:
a first lower maintenance part configured to connect a lower part of the side chamber part and a lower part of the seat part; and
a second lower maintenance part configured to connect a lower part of the front chamber part and a lower part of the seat part.

12. The airbag cushion of claim 11, wherein the first lower maintenance part and the second lower maintenance part are overlapped and fixed to the seat part.

13. A folding method of an airbag cushion, the method comprising:
a first folding step of folding a front chamber part configured to protect a passenger by being deployed toward a front of the passenger, the front chamber part connected to a seat part;
a second folding step of folding a third side part connected to the front chamber part, the third side part configured to include a third hole part formed therein, and connected to the seat part;
a third folding step of folding a second side part connected to the third side part, the second side part configured to protect a side of the passenger; and
a fourth folding step of folding a first side part connected to the second side part and an inflator.

14. The method of claim 13, wherein the first folding step comprises folding the front chamber part in a tuck-in way to fold the front chamber part by pushing an end of the front chamber part inward.

15. The method of claim 13, wherein the second folding step comprises folding the third side part in an inboard roll way to fold the third side part toward a direction of the passenger.

16. The method of claim 13, wherein the third folding step comprises folding the second side part in an outboard roll way to fold the second side part in an external direction of the passenger so that the second side part is deployed beyond a shoulder portion of the passenger.

17. The method of claim 13, wherein the fourth folding step comprises folding the first side part in one or more zigzag patterns so that the first side part is deployed in a lateral direction of the passenger.

18. An airbag cushion for a vehicle, the airbag cushion comprising:
an airbag inflator;
a side chamber part connected to the airbag inflator and configured to be integrated with a seat of the vehicle;
a front chamber part connected to the side chamber part and configured to be integrated in the seat of the vehicle;
a shape maintenance part configured to attach to the seat and connect at least one of the side chamber part, the front chamber part, or a combination thereof to the seat,
wherein, in response to the inflator being deployed,
pressurized gas released by the inflator deploys the side chamber part to protect a side of the passenger seated in the seat,
the pressurized gas in the side chamber part deploys the front chamber part to protect a front of the passenger seated in the seat, and the shape maintenance part is further configured to maintain the front chamber part as being bent from the side chamber part.

19. The airbag cushion of claim 18, wherein, after the side chamber part and the front chamber part are deployed, the shape maintenance part maintains the side chamber part and the front chamber part as an L-shape when viewed from above, to protect the front and the side of the passenger.

20. The airbag cushion of claim 18, further comprising:
another side chamber part connected to the airbag inflator and configured to be integrated with the seat of the vehicle; and
another front chamber part connected to the other side chamber part and configured to be integrated in the seat of the vehicle,
wherein the shape maintenance part is further configured to connect at least one of the other side chamber part, the other front chamber part, or a combination thereof to the seat, and
wherein, in response to the inflator being deployed,
pressurized gas released by the inflator deploys the other side chamber part to protect another side of the passenger seated in the seat,
the pressurized gas in the other side chamber part deploys the other front chamber part to protect the front of the passenger seated in the seat, and
the shape maintenance part is further configured to maintain the other front chamber part as being bent from the other side chamber part.
